(19) United States
(12) Patent Application Publication
(10) Pub. No.: US 2021/0370142 A1
(43) Pub. Date: Dec. 2, 2021

(54) Sportsball Construction with Antimicrobial Function

(71) Applicant: Tsung Ming OU, Kaohsiung (TW)

(72) Inventor: Tsung Ming OU, Kaohsiung (TW)

(21) Appl. No.: 16/891,006

(22) Filed: Jun. 2, 2020

(51) Int. Cl. A63B 41/08; A01N 59/20; A01N 59/12; A63B 41/02

(52) U.S. Cl. CPC A63B 41/08; A01N 59/20; A01N 59/12; A63B 37/12; A63B 2209/00; A63B 2225/62; A63B 2243/0037; A63B 41/02

(57) ABSTRACT

An antimicrobial sportsball includes a ball carcass having an interior cavity and an antimicrobial ball cover, covering the ball carcass. The antimicrobial ball cover contains and releases antimicrobial agent to the ball surface and the environment. The ball carcass includes an inflatable bladder adapted to be inflated into a designated size and shape and a cushion layer covering the inflatable wound or lined bladder, so as to provide additional cushioning effect and form channels.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates a ball, and more particularly to a sportsball comprising an antimicrobial polyurethane composite ball cover to contain and release at least one antimicrobial agent.

### Description of Related Arts

Sportsball has played an important role in the recreation and fitness domains. Unfortunately, players in various regions or periods put down their feet because of the boost concern of microbe infection and suffer from losses in social connection, entertainment, and physical wellbeing.

The concern of most microbe infection has to do with contact infection. That is, a healthy person may be infected through contact with the surrounding environment of a contaminated patient. For instance, discharges (e.g. nasal discharge, saliva, tear, sweat and etc.) of a contaminated patient that carry microbes in many cases can be stained on the patient's hands and dropped on the floor easily even s/he is very cautious. Once a healthy person incidentally contacts an object (e.g. the sportsball) that has been directly or indirectly contacted by the patients or the contaminated floor, the healthy person may therefore be infected if s/he touches any of his/her mucous (e.g. in the eyes, nose, mouth, and etc.) with the contaminated positions (i.e. mostly his/her hands). Based on this phenomenon, players playing with a contaminated sportsball and on a contaminated sports court/field floor can both be under a risk of being infected.

In order to address the above issue and encourage players to return to the sport games, a ball with antimicrobial function that is capable of sanitizing its own surface as well as other objects, such as the players' hands and clothing, the floor, and etc., has become one of the most important tasks to preserve the health of athletes without compromising the durability and performance of a sports ball.

Besides, conventional solutions regarding the above purposes usually provide some type of antimicrobial spray or paint for the players to spray or apply on the ball they are about to play with. Unfortunately, such product can only solve some of the issues in a very limited extent because the spray or paint can only be applied on the surface of ball for a very thin layer and is very likely to come off in a short period of time. As a result, the players have to constantly stop playing and start applying the product on the ball again in order to replenish the antimicrobial agent on the surface of the ball and ensure that the antimicrobial function of the ball is sufficient to protect them. In addition, such antimicrobial spray or paint materials are very likely to have negative impact on the surface texture as well as other surface properties of the ball, which will diminish the quality of the game and may not be allowed in most of the competitive games.

### SUMMARY OF THE PRESENT INVENTION

An object of the present invention is to provide an antimicrobial sportsball, which includes a ball carcass and an antimicrobial ball cover, for example made of polyurethane composite, covering the ball carcass, wherein the antimicrobial ball cover is capable of sanitizing its own surface as well as other objects it might have contacted, such that the ball is prevented from microbial contamination and might be able to extend the antimicrobial function to other objects and surfaces that have directly and/or indirectly contacted the ball. The antimicrobial polyurethane composite made ball cover is made of the polyurethane foam coating on top of a layer of non-woven base cloth (which can be microfiber). The antimicrobial agent is formulated and blended into the polyurethane foam coating as the surface layer. Also, the top polyurethane foam coating layer can be embossed to any pebble shape or leather grain type as necessary for a sports ball. The range of thickness can be 0.8 mm to 2.0 mm for the antimicrobial polyurethane composite ball cover.

Another object of the present invention is to provide an antimicrobial sportsball, wherein the antimicrobial polyurethane composite ball cover is capable of containing and releasing the antimicrobial agent to neutralize the microbial contaminant left on the surface of the ball instantly or shortly after.

Another object of the present invention is to provide an antimicrobial sportsball, wherein the antimicrobial ball cover is capable of releasing at least one antimicrobial agent to the environment so as to build and accumulate protections on the surfaces, including the players' hands and clothing, the sports court/field floor, the dust in the sports field, the sports equipment like the backboard, the rim, and the net, and etc., directly and indirectly, wherein such antimicrobial agent remains on the surface of the ball to provide a long lasting protection.

Another object of the present invention is to provide an antimicrobial sportsball, wherein the antimicrobial ball cover is capable of releasing at least one antimicrobial agent to the external contact surfaces, such that the antimicrobial agent can be preserved in the antimicrobial polyurethane composite ball cover throughout the entire product life cycle when the ball is stored and the ball can release the antimicrobial agent more and more often when it is played with and, consequently, contacted with the players as well as other environmental means (e.g. the floor, the hoop, and etc.) more frequently.

Another object of the present invention is to provide an antimicrobial sportsball, wherein the antimicrobial agent is released by the antimicrobial ball cover rather than being simply stained on the ball through other means (e.g. being sprayed or applied on the ball), such that the ball is capable of carrying more antimicrobial agent for releasing the antimicrobial agent throughout the entire product life cycle.

Another object of the present invention is to provide an antimicrobial sportsball, wherein the antimicrobial agent is released by the antimicrobial ball cover rather than being simply stained on the ball through other means (e.g. being sprayed or applied on the ball), such that the surface texture, grip feel, abrasion resistance as well as other features of the ball can be assured without being affected or compromised by additional agent externally applied thereon.

Another object of the present invention is to provide an antimicrobial sportsball, wherein the antimicrobial ball cover has channels arranged between cover panels on the surface thereof so as to help the user to grip the ball better and enhance the delivery of the antimicrobial agent to the player's contact skin and the environment.

Another object of the present invention is to provide an antimicrobial sportsball, wherein the ball is capable of comforting the players, providing a sense of security, and encouraging them to conduct more sports activities through the antimicrobial function of the ball, when there is a microbe infection concern.

Another object of the present invention is to provide an antimicrobial sportsball, which can be an inflatable ball or a non-inflatable ball.

According to a preferred embodiment, the ball carcass comprises an inflatable bladder inside, having a valve stem mounted thereon, disposed in the ball carcass, wherein an end of the valve stem is exposed on the antimicrobial polyurethane composite ball cover, so as to allow the bladder inside of the ball carcass to be inflated and deflated through the valve stem.

In order to achieve the above and other objects, the present invention provides an antimicrobial sportsball, which includes:

a ball carcass having an interior cavity; and

an antimicrobial ball cover, covering the ball carcass, wherein the antimicrobial ball cover contains and releases antimicrobial agent to the ball surface and the environment.

According to a preferred embodiment, the ball carcass includes an inflatable wound or lined bladder adapted to be inflated into a designated size and shape and a cushion layer covering the inflatable bladder, so as to provide additional cushioning effect and form channels for easier grip.

According to a preferred embodiment, the ball carcass further includes a reinforced layer which is a winding or lining layer arranged between the cushion layer and the inflatable bladder, so as for the shape retention of the antimicrobial sportsball.

According to a preferred embodiment, the inflatable bladder has a valve stem mounted thereon, wherein an end of the valve stem is exposed on the antimicrobial ball cover, so as to allow the ball to be inflated or deflated through the valve stem.

According to a preferred embodiment, the antimicrobial polyurethane composite made ball cover has channels arranged on the surface thereof so as to facilitate grip of the ball and enhance the delivery of the antimicrobial agent to the player's contact skin and the environment.

According to a preferred embodiment, the antimicrobial ball cover is made of polyurethane composite material that contains copper iodide, which releases copper ion as the antimicrobial agent to the environment.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a partial sectional view of an antimicrobial sportsball according to a first preferred embodiment of the present invention.

FIG. 2 is a perspective view of the antimicrobial sportsball according to the above first preferred embodiment of the present invention.

FIG. 3 is a partial sectional view of part of the antimicrobial sportsball according to the above first preferred embodiment of the present invention.

FIGS. 4A-4C are pictures of an antimicrobial ball cover of the antimicrobial sportsball according to the above first preferred embodiment of the present invention.

FIG. 5 is an application scenario of the antimicrobial sportsball according to the above first preferred embodiment of the present invention.

FIG. 6 is a perspective view of an antimicrobial sportsball according to a second preferred embodiment of the present invention.

FIG. 7 is a perspective view of an antimicrobial sportsball according to a third preferred embodiment of the present invention.

FIG. 8 is a perspective view of an antimicrobial sportsball according to a fourth preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

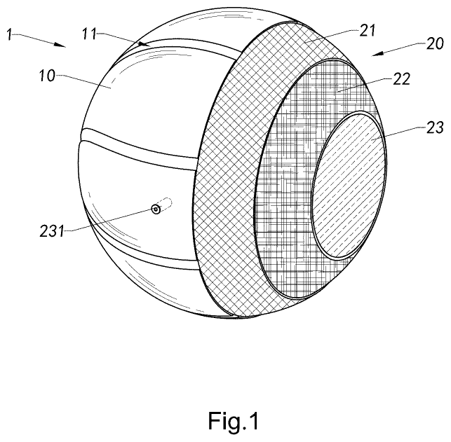

First of all, referring to FIG. 1, an antimicrobial sportsball 1 according to a first preferred embodiment of the present invention includes a ball carcass 20 having an interior cavity and an antimicrobial ball cover 10, preferred to be made of polyurethane composite when the sportsball 1 is a basketball for example, covering the ball carcass 20. The antimicrobial ball cover 10 has eight channels 11 arranged on the surface thereof so as to help the user to grip the ball and enhance the delivery of the antimicrobial agent to the environment. The ball carcass 20 includes a cushion layer 21, a reinforced layer 22 which is embodied as a winding or lining layer 22, and an inflatable bladder 23, wherein the inflatable bladder 23 has a valve stem 231 mounted thereon, wherein an end of the valve stem 231 is exposed on the antimicrobial ball cover 10.

It is worth mentioning that the term “environment” indicated in the present specification, including the appended claims thereof, refers to all of the objects, surfaces, and space around the antimicrobial sportsball 1, which include but not limited to the surface of the antimicrobial sportsball 1 itself, the players' hands, bodies, and clothing, the sports court/field floor, the mist, dust, water, grass, and mud in the sports field, the sports equipment like the backboard, rim, net, cue, goal, and etc.

The inflatable bladder body 23 is made of a flexible material (such as rubber, polyurethane sheet, or latex) with a structure has an interior cavity, so as to allow the user to utilize the valve stem 231 mounted thereon to inflate or deflate the antimicrobial sportsball 1 through inflating or deflating the inflatable bladder 23. The reinforced layer 22 is a layer covering over the inflatable bladder 23 and constructed through at least one winding thread or a layer of lining cloth, so as for further enhance the strengths of the ball carcass 20 and assure and endure the ball carcass 20 to remain in the designated size and shape (e.g. true roundness and etc.) when inflated. The cushion layer 21 covering on the reinforced layer 22 is made of natural or synthetic rubber or other soft elastic materials (such as styrene butadiene rubber, PVC, foaming materials, etc.) for providing a cushioning effect of the inflated antimicrobial sportsball 1.

The antimicrobial ball cover 10 serves as not only the conventional external layer of a ball that provides mostly the abrasion resistance, the frictional effect (grip feel), and some cushioning effect of the ball, but also an antimicrobial means on the surface of the ball for protecting the ball surface to be contacted with the users with antimicrobial agent and/or releasing antimicrobial agent to the environment such that the antimicrobial ball cover 10 is capable of sanitizing its own surface as well as other objects it has contacted thereby. After a period of time, the antimicrobial agent can further be accumulated in the environment of the antimicrobial sportsball 1, which will maximize antimicrobial effect around the ball. Namely, the antimicrobial sportsball 1 not only sanitize the environment to neutralize the microbial contaminant left in the environment, but also leave antimicrobial agent in the environment in order to neutralize the microbial contaminant that may be left in the environment later.

Further specifically, it is worth mentioning that, in most ball game fields, matters like players' discharges (e.g. nasal discharge, saliva, tear, sweat, and etc.) and other environmental materials (e.g. mud, dust, and etc.) are very likely to hazard the players in several ways that are mostly impossible to completely avoid. First, some of the matters may carry a pathogenic microbe that once a player touches it directly (e.g. touches the discharge left on the ground of the sports field and etc.) or indirectly (e.g. touches a contaminated ball and etc.), s/he is under a risk of being infected thereby. Second, other matters that do not carry any pathogenic microbe may also be a medium and/or breeding ground that help the microbe to spread and/or reproduce. Accordingly, the present invention aims to not only provide an antimicrobial sportsball 1 that is capable of sanitizing its own surface and being prevented from microbial contamination, but, most importantly, to allow the ball to sanitize itself and the environment during the ball game and to extend the antimicrobial function to other objects and surfaces that have directly and/or indirectly contacted the ball, such that the microbial threat of a ball game can really be reduced effectively and significantly. Based on such effective antimicrobial function, the players can therefore feel safer and more confident playing in the ball game when there is microbial hazard concern anytime anywhere.

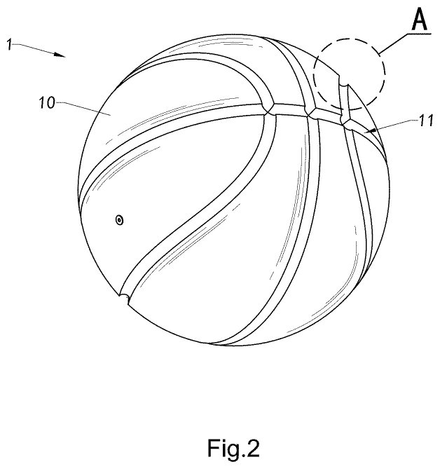

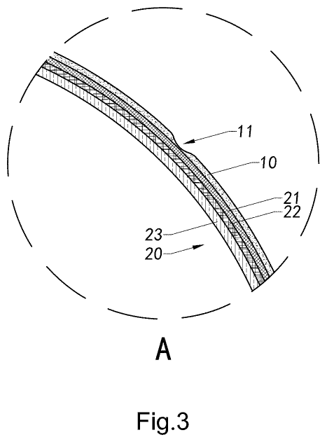

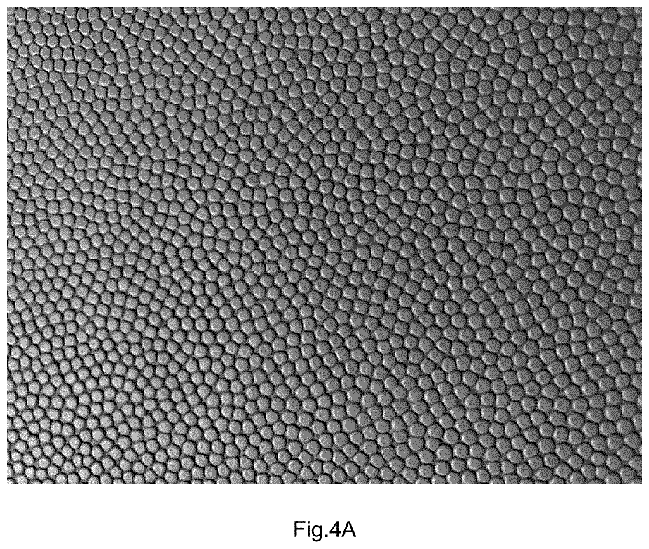

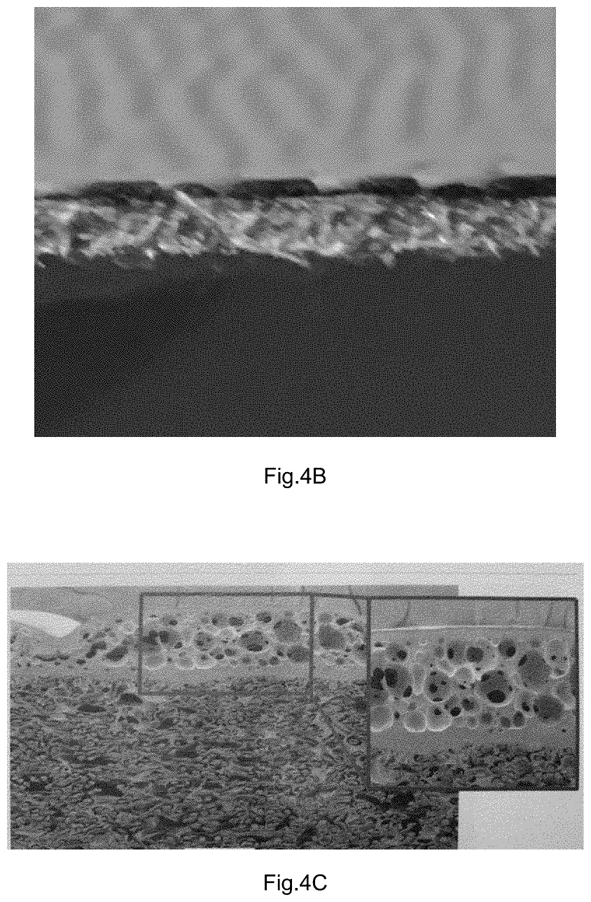

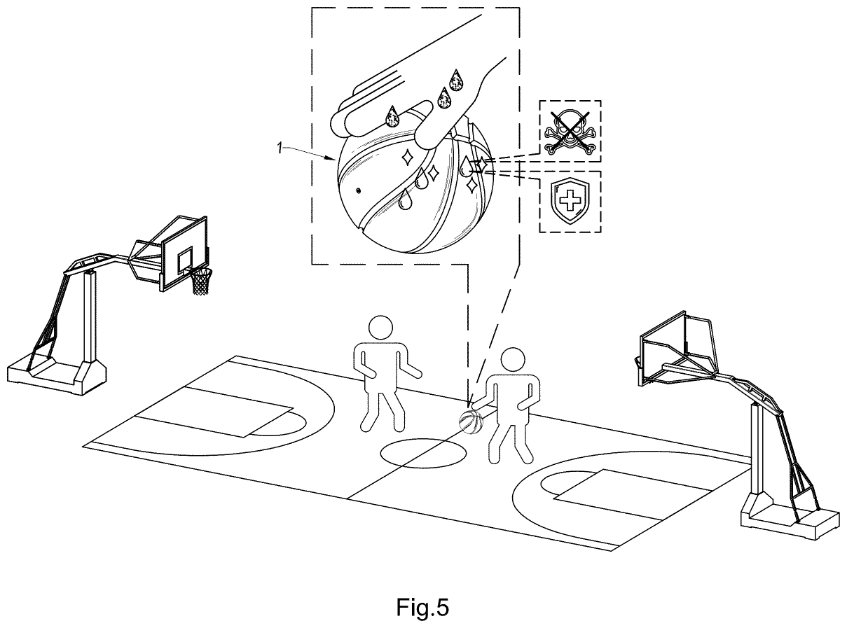

According to the above first preferred embodiment, referring to FIGS. 1-4C, the antimicrobial ball cover 10 is embodied as made of a polyurethane (PU) composite material base containing copper iodide, which is able to continuously and stably releasing copper ion into the environment to kill microbes (e.g. fungi, bacteria, viruses, parasites, and etc.) through contact. In other words, on the one hand, every time when the antimicrobial sportsball 1 contacts an object of the environment (e.g. the player's hand, the floor, etc.) the antimicrobial ball cover 10 will transfer a certain amount of the copper ion to the object, especially if there is more water or moisture on the object, on the surface of the ball, or in the air. In this case, sweat of the players also helps the releasing and delivery of the copper ion (or other antimicrobial agent). On the other hand, as the antimicrobial sportsball 1 is stored on the shelf, the copper ion (or other antimicrobial agent) will mostly be held in the antimicrobial ball cover 10 instead of being released, such that the antimicrobial power of the ball can be preserved for a relatively long time.

It is also worth mentioning that the copper ion released to the environment will stay active for a long period as well, which allows the protections to be accumulated in the environment, including the surface of the ball, the players' hands and cloth, the sports field floor, the dust in the sports field, the sports equipment like the backboard, the rim, and the net, and etc.

According to this embodiment, copper ion is preferred for being released from the ball as a sanitizer because it has been widely proven useful and effective in killing microbes of a broad spectrum, especially for bacteria and viruses. That is to say, copper ion is capable of killing and inhibiting most of the bacteria and viruses in addition to some other microbes (e.g. fungi, parasites, and etc.). Nevertheless, according to other implementations, the antimicrobial ball cover 10 may also be made of other material that contains and releases other antimicrobial agent, such as silver salt, ammonium salts, chloride salts, and etc. As long as the antimicrobial ball cover 10 is capable of releasing at least one antimicrobial agent, it shall be within the scope of the present invention and the present invention shall not be limited hereby.

Further, the eight channels 11 arranged on the surface of the antimicrobial ball cover 10 is to not only help the user to grip the antimicrobial sportsball 1, but also to enhance the delivery of the antimicrobial agent to the environment through increasing the surface area of the antimicrobial ball cover 10. Besides, matters like players' discharges (e.g. nasal discharge, saliva, tear, sweat, and etc.) and other environmental materials (e.g. mud, dust, and etc.) are more likely to be temporally trapped in the channels 11 to absorb more antimicrobial agent, such that once these matters are dropped and stained on player's hands, body, and clothing or the surroundings, such as the ground of the sports court/field, the hoop, and etc. afterwards, these matters that contain higher dosage of the antimicrobial agent may further help to sanitize their surrounding environment for a period of time.

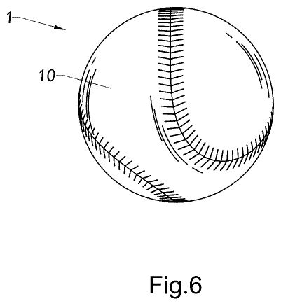

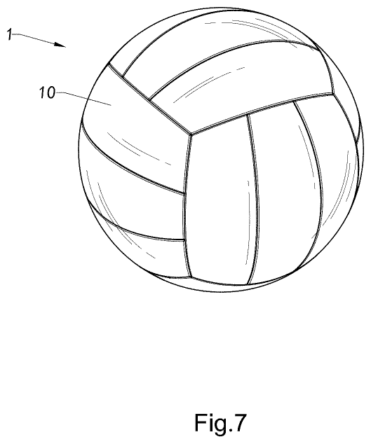

Referring to FIG. 6, an antimicrobial sportsball 1 according to a second preferred embodiment of the present invention is a non-inflatable sportsball, which also includes a ball carcass with a rubber foam, polyurethane foam, or cork mixture solid center core, and an antimicrobial polyurethane composite ball cover 10 covering thereon to release antimicrobial agent into the environment.

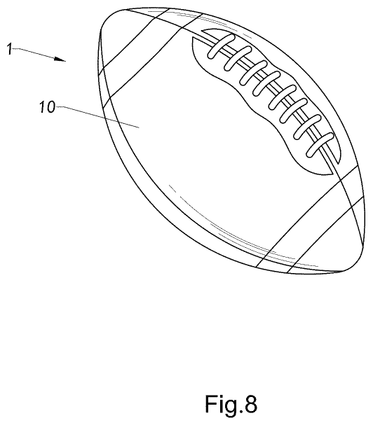

Referring to FIGS. 7-8, the antimicrobial sportsball 1 according to different embodiments of the present invention may also be implemented into various types of ball. That is, the present invention shall not be limited to certain type of ball.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. An antimicrobial sportsball, comprising:
a ball carcass having an interior cavity; and
an antimicrobial ball cover, covering said ball carcass to form a sportsball, wherein said antimicrobial ball cover is made of polyurethane composite and an antimicrobial agent, wherein said antimicrobial agent is continuously and stably released from said polyurethane composite to a surface of said antimicrobial ball cover to serve as a sanitizer when said sportsball is played and contacted to an environment.

2. The antimicrobial sportsball, as recited in claim 1, wherein said ball carcass comprises an inflatable bladder adapted to be inflated into a designated size and shape and a cushion layer covering said inflatable bladder, so as to provide additional cushioning effect.

3. The antimicrobial sportsball, as recited in claim 2, wherein said ball carcass further comprises a reinforced layer arranged between said cushion layer and said inflatable bladder to strength said ball carcass.

4. The antimicrobial sportsball, as recited in claim 2, wherein said inflatable bladder has a valve stem mounted thereon, wherein an end of said valve stem is exposed on said antimicrobial ball cover, so as to allow said sportsball to be inflated or deflated through said valve stem.

5. The antimicrobial sportsball, as recited in claim 3, wherein said inflatable bladder has a valve stem mounted thereon, wherein an end of said valve stem is exposed on said antimicrobial ball cover, so as to allow said sportsball to be inflated or deflated through said valve stem.

6. The antimicrobial sportsball, as recited in claim 1, wherein said antimicrobial ball cover has at least one channel arranged on said surface thereof for facilitating gripping said sportsball, wherein said antimicrobial agent is continuously released along said channel.

7. The antimicrobial sportsball, as recited in claim 2, wherein said antimicrobial ball cover has at least one channel arranged on said surface thereof for facilitating gripping said sportsball, wherein said antimicrobial agent is continuously released along said channel.

8. The antimicrobial sportsball, as recited in claim 3, wherein said antimicrobial ball cover has at least one channel arranged on said surface thereof for facilitating gripping said sportsball, wherein said antimicrobial agent is continuously released along said channel.

9. The antimicrobial sportsball, as recited in claim 1, wherein said antimicrobial agent comprises copper iodide blended into said polyurethane composite to release copper ions from said antimicrobial ball cover.

10. The antimicrobial sportsball, as recited in claim 2, wherein said antimicrobial agent comprises copper iodide blended into said polyurethane composite to release copper ions from said antimicrobial ball cover.

11. The antimicrobial sportsball, as recited in claim 3, wherein said antimicrobial agent comprises copper iodide blended into said polyurethane composite to release copper ions from said antimicrobial ball cover.

12. The antimicrobial sportsball, as recited in claim 6, wherein said antimicrobial agent comprises copper iodide blended into said polyurethane composite to release copper ions from said antimicrobial ball cover.

13. The antimicrobial sportsball, as recited in claim 1, wherein said antimicrobial ball cover is made of a polyurethane foam, wherein said antimicrobial agent is blended into said polyurethane foam as a surface layer.

14. The antimicrobial sportsball, as recited in claim 11, wherein said antimicrobial ball cover is made of a polyurethane foam, wherein said antimicrobial agent is blended into said polyurethane foam as a surface layer.

15. The antimicrobial sportsball, as recited in claim 12, wherein said antimicrobial ball cover is made of a polyurethane foam, wherein said antimicrobial agent is blended into said polyurethane foam as a surface layer.

16. The antimicrobial sportsball, as recited in claim 13, wherein said antimicrobial ball cover further comprises a layer of non-woven base cloth, wherein said polyurethane foam is coated on top of said layer of said non-woven base cloth, wherein said polyurethane foam coating layer is embossed to pebble shape or leather grain.

17. The antimicrobial sportsball, as recited in claim 14, wherein said antimicrobial ball cover further comprises a layer of non-woven base cloth, wherein said polyurethane foam is coated on top of said layer of said non-woven base cloth, wherein said polyurethane foam coating layer is embossed to pebble shape or leather grain.

18. The antimicrobial sportsball, as recited in claim 15, wherein said antimicrobial ball cover further comprises a layer of non-woven base cloth, wherein said polyurethane foam is coated on top of said layer of said non-woven base cloth, wherein said polyurethane foam coating layer is embossed to pebble shape or leather grain.

19. The antimicrobial sportsball, as recited in claim 1, wherein a thickness of said antimicrobial ball cover has a range between 0.8 mm and 2.0 mm.

20. The antimicrobial sportsball, as recited in claim 18, wherein a thickness of said antimicrobial ball cover has a range between 0.8 mm and 2.0 mm.
